(19) United States
(12) Patent Application Publication
(10) Pub. No.: US 2026/0279851 A1
(43) Pub. Date: Sep. 17, 2026

(54) HYBRID SEAL FOR ELECTROCHEMICAL CELL

(71) Applicants: GM Global Technology Operations LLC, Detroit, MI (US); Proton Energy Systems, Inc., Wallingford, CT (US)

(72) Inventors: Swaminatha P. Kumaraguru, Rochester Hills, MI (US); Jeremy William Dabel, Oxford, MI (US); Yeh-Hung Lai, Oakland, MI (US); Mohammad Morshed Moshiur Hasan, Auburn Hills, MI (US); Mahesh Biradar, Auburn Hills, MI (US); Krishna Garapati, Troy, MI (US); Allyssa Murphy, Monroe, CT (US); Andrew Roemer, Pomfret Center, CT (US); Luke Dalton, Cromwell, CT (US)

(73) Assignees: GM Global Technology Operations LLC, Detroit, MI (US); Proton Energy Systems, Inc., Wallingford, CT (US)

(21) Appl. No.: 19/078,613

(22) Filed: Mar. 13, 2025

(51) Int. Cl. H01M 8/0284; B60R 16/033; H01M 8/0228; H01M 8/0247; H01M 8/1004; H01M 8/241

(52) U.S. Cl. CPC H01M 8/0284; H01M 8/0228; H01M 8/0247; H01M 8/1004; H01M 8/241; B60R 16/033; H01M 2250/20

(57) ABSTRACT

A bipolar plate of an electrochemical cell includes a metallic anode plate, a metallic cathode plate, a bead region, and an elastomeric bead. An interior side of the cathode plate faces an interior side of the anode plate. A portion of the interior side of the anode plate at the bead region is spaced from a portion of the interior side of the cathode plate at the bead region. The elastomeric bead includes a first portion and a second portion. The first portion is disposed at an exterior side of the anode plate at the bead region, and the second portion is disposed at an exterior side of the cathode plate at the bead region. The elastomeric bead and the bead region are configured to cooperatively resist compression forces experienced at the bipolar plate.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an electrochemical conversion cell system that utilizes hydrogen, such as an electrolysis cell system or a fuel cell system in connection with a vehicle, and more particularly, to bipolar plates used in the electrochemical cell system. Specifically, the present disclosure provides a bipolar plate for an electrochemical cell system having a bead region and an elastomeric bead disposed at the bead region.

Bipolar plates within the electrochemical cell system are generally configured as current collectors that support fluid flow to facilitate uniform electrochemical reactions. For example, the electrochemical cell system can be a fuel cell system that is used generate electricity from a fuel source, such as hydrogen, to provide propulsion to the vehicle. In another example, the electrochemical cell system can be an electrolysis cell system used to generate clean hydrogen from water with use of electrical energy. Both types of electrochemical cell systems share common components such as the bipolar plates, electrodes, electrolytes, and catalysts.

Fuel cell systems that are configured to power propulsion systems of vehicles, such as passenger vehicles and commercial vehicles, commonly include a fuel cell stack having a plurality of fuel cells connected in series by stacking the fuel cells on top of each other. Typically, each fuel cell of the plurality of fuel cells includes a membrane electrode assembly sandwiched between a pair of bipolar plates. The bipolar plates of adjacent cells engage one another to provide an electrically conductive connection between the cells, add physical strength to the fuel cell stack, and may seal a flow field and a header region that extend across the bipolar plate and/or the membrane electrode assembly. Compression forces between the cells may maintain a seal between adjacent bipolar plates, at the flow field, and at the header region. Redox reactions occur within the fuel cell system in which electrodes either gain or lose electrons when ions move through the electrolyte to complete electrical circuits. The bipolar plates support the electrical connection between the plurality of fuel cells and provide gas separation, gas distribution, structural support, and facilitate heat and fluid management.

The bipolar plate includes an anode plate and a cathode plate that are joined together. In some instances, the bipolar plate includes a chamber between respective interior sides of the anode plate and the cathode plate, thus accommodating pathways for fluid flow between the header region and the flow field. Further, the chamber may also assist in sealing pressurized gases between the bipolar plate and the membrane electrode assembly that develop during operation of the fuel cell system. The chamber results from the anode plate and the cathode plate being spaced apart from one another at least at a bead region of the bipolar plate. Alternatively, the bipolar plate may be flat, with the interior sides of the anode plate and the cathode plate engaged with one another, and with the bipolar plate including a flexible or rubber-like seal at the exterior sides of the flat anode and cathode plates that is configured to seal pressurized gases between the bipolar plate and the membrane electrode assembly. Further, sealing various openings between the headers and the flow fields is required to maintain various fluid pathways at the bipolar plates. However, the flexible seal lacks accommodations for pathways between the header region and the fluid flow field. It is desired to provide robust sealing capabilities between the bipolar plate and the membrane electrode assembly while concurrently accommodating pathways for fluid flow between the header region and the fluid flow field.

### SUMMARY

One aspect of the disclosure provides a bipolar plate. The bipolar plate includes a metallic anode plate, a metallic cathode plate, a bead region, and an elastomeric bead. The metallic anode plate has an interior side and an exterior side opposite the interior side. The metallic cathode plate has an interior side and an exterior side opposite the interior side. The interior side of the cathode plate faces the interior side of the anode plate. A portion of the interior side of the anode plate at the bead region is spaced from a portion of the interior side of the cathode plate at the bead region. The elastomeric bead includes a first portion and a second portion. The first portion is disposed at the exterior side of the anode plate at the bead region, and the second portion is disposed at the exterior side of the cathode plate at the bead region. The elastomeric bead and the bead region are configured to cooperatively resist compression forces experienced at the bipolar plate.

Implementations of this aspect of the disclosure may include one or more of the following optional features. In some examples, the portion of the anode plate at the bead region includes a protrusion extending away from the cathode plate. The first portion of the elastomeric bead is disposed at the portion of the anode plate at the bead region and is adjacent to the protrusion. In some further examples, the first portion of the elastomeric bead extends a distance away from the cathode plate that is greater than a distance the protrusion extends away from the cathode plate.

In some implementations, the portion of the anode plate at the bead region includes a pair of protrusions extending away from the cathode plate. The first portion of the elastomeric bead is disposed at the portion of the anode plate at the bead region and is between the pair of protrusions.

In some configurations, the portion of the cathode plate at the bead region includes a protrusion extending away from the anode plate. The second portion of the elastomeric bead is disposed at the portion of the cathode plate at the bead region and is adjacent to the protrusion. In some further configurations, the second portion of the elastomeric bead extends a distance away from the anode plate that is greater than a distance the protrusion extends away from the anode plate.

In some examples, the portion of the cathode plate at the bead region includes a pair of protrusions extending away from the anode plate. The second portion of the elastomeric bead is disposed at the portion of the cathode plate at the bead region and is between the pair of protrusions.

In some implementations, portions of the interior side of the anode plate adjacent to the bead region and portions of the interior side of the cathode plate adjacent to the bead region engage one another.

In some configurations, at least one selected from the group consisting of (i) the anode plate includes a contoured surface at the bead region to space the portion of the interior side of the anode plate at the bead region from the portion of the interior side of the cathode plate at the bead region and (ii) the cathode plate includes a contoured surface at the bead region to space the portion of the interior side of the cathode plate at the bead region from the portion of the interior side of the anode plate at the bead region.

In some examples, the elastomeric bead includes at least one selected from the group consisting of i) a silicone-based polymer, ii) an acrylic-based polymer, iii) a urethane-based polymer, iv) an ethylene propylene diene terpolymer, and v) a fluorocarbon-based fluoroelastomer.

Another aspect of the disclosure provides an electrochemical cell system. The electrochemical cell system includes an electrochemical cell stack. The electrochemical cell stack includes a plurality of electrochemical cells, wherein at least one electrochemical cell of the plurality of electrochemical cells includes a membrane electrode assembly sandwiched between a pair of bipolar plates. Each bipolar plate of the pair of bipolar plates includes a metallic anode plate, a metallic cathode plate, a bead region, and an elastomeric bead. The metallic anode plate has an interior side and an exterior side opposite the interior side. The metallic cathode plate has an interior side and an exterior side opposite the interior side. The interior side of the cathode plate faces the interior side of the anode plate. A portion of the interior side of the anode plate at the bead region is spaced from a portion of the interior side of the cathode plate at the bead region. The elastomeric bead includes a first portion and a second portion. The first portion is disposed at the exterior side of the anode plate at the bead region, and the second portion is disposed at the exterior side of the cathode plate at the bead region. The elastomeric bead and the bead region are configured to cooperatively resist compression forces experienced at the bipolar plate.

Implementations of this aspect of the disclosure may include one or more of the following optional features. In some examples, the portion of the anode plate at the bead region includes a protrusion extending away from the cathode plate. The first portion of the elastomeric bead is disposed at the portion of the anode plate at the bead region and is adjacent to the protrusion.

In some implementations, the portion of the anode plate at the bead region includes a pair of protrusions extending away from the cathode plate. The first portion of the elastomeric bead is disposed at the portion of the anode plate at the bead region and is between the pair of protrusions.

In some configurations, the portion of the cathode plate at the bead region includes a protrusion extending away from the anode plate. The second portion of the elastomeric bead is disposed at the portion of the cathode plate at the bead region and is adjacent to the protrusion.

In some examples, the portion of the cathode plate at the bead region includes a pair of protrusions extending away from the anode plate. The second portion of the elastomeric bead is disposed at the portion of the cathode plate at the bead region and is between the pair of protrusions.

Yet another aspect of the disclosure provides a system operable with a vehicle. The system includes an electrochemical cell stack. The electrochemical cell stack includes a plurality of electrochemical cells, wherein at least one electrochemical cell of the plurality of electrochemical cells includes a membrane electrode assembly sandwiched between a pair of bipolar plates. Each bipolar plate of the pair of bipolar plates includes a metallic anode plate, a metallic cathode plate, a bead region, and an elastomeric bead. The metallic anode plate has an interior side and an exterior side opposite the interior side. The metallic cathode plate has an interior side and an exterior side opposite the interior side. The interior side of the cathode plate faces the interior side of the anode plate. A portion of the interior side of the anode plate at the bead region is spaced from a portion of the interior side of the cathode plate at the bead region. The elastomeric bead includes a first portion and a second portion. The first portion is disposed at the exterior side of the anode plate at the bead region, and the second portion disposed at the exterior side of the cathode plate at the bead region. The elastomeric bead and the bead region are configured to cooperatively resist compression forces experienced at the bipolar plate.

Implementations of this aspect of the disclosure may include one or more of the following optional features. In some examples, the portion of the anode plate at the bead region includes a protrusion extending away from the cathode plate. The first portion of the elastomeric bead is disposed at the portion of the anode plate at the bead region and is adjacent to the protrusion.

In some implementations, the portion of the anode plate at the bead region includes a pair of protrusions extending away from the cathode plate. The first portion of the elastomeric bead is disposed at the portion of the anode plate at the bead region and is between the pair of protrusions.

In some configurations, the portion of the cathode plate at the bead region includes a protrusion extending away from the anode plate. The second portion of the elastomeric bead is disposed at the portion of the cathode plate at the bead region and is adjacent to the protrusion.

In some examples, the portion of the cathode plate at the bead region includes a pair of protrusions extending away from the anode plate. The second portion of the elastomeric bead is disposed at the portion of the cathode plate at the bead region and is between the pair of protrusions.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including an electrochemical cell system according to the present disclosure;

FIG. 2 is an exploded view of an electrochemical cell stack of the electrochemical cell system of FIG. 1;

FIG. 3 is a plan view of a bipolar plate of the electrochemical cell system of FIG. 1;

FIG. 4 is a perspective cross-sectional view of an electrochemical cell of the electrochemical cell stack of FIG. 2 at bead regions of adjacent bipolar plates taken at line 4-4 of FIG. 3;

FIG. 5 is a perspective cross-sectional view of the bead region of one bipolar plate of FIG. 4;

FIG. 6A is a front cross-sectional view of the bead region of the bipolar plate of FIG. 5;

FIG. 6B is a front cross-sectional view of the bead region of the bipolar plate of FIG. 5 with an alternate configuration;

FIG. 6C is a front cross-sectional view of the bead region of the bipolar plate of FIG. 5 with an alternate configuration;

FIG. 6D is a front cross-sectional view of the bead region of the bipolar plate of FIG. 5 with an alternate configuration;

FIG. 6E is a front cross-sectional view of the bead region of the bipolar plate of FIG. 5 with an alternate configuration; and

FIG. 6F is a front cross-sectional view of the bead region of the bipolar plate of FIG. 5 with an alternate configuration.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While some configurations herein refer to a “fuel cell system” for use in a movable vehicle, such as an automobile, it should be appreciated that this is for example purposes and the claims should not be so limited. In other configurations, the claimed electrochemical system is an electrolysis system that produces hydrogen. In further configurations, the electrochemical system may be a stationary fuel cell system, a movable electrolysis system, or a stationary electrolysis system without deviating from the teachings provided herein.

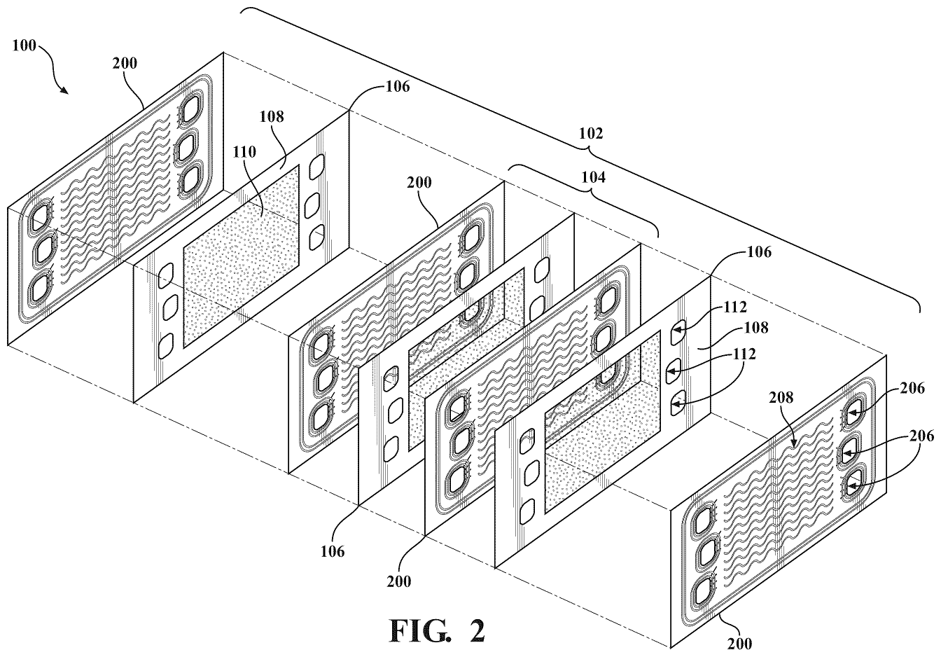

Referring now to the figures and the illustrated configurations depicted therein, an electrochemical cell system 100 for powering a propulsion system of a vehicle 10 (e.g., a passenger vehicle, a mass transit vehicle, a commercial vehicle, and the like) includes an electrochemical cell stack 102 having a plurality of power generation cells or electrochemical cells 104 (FIG. 2). For example, the electrochemical cell system 100 may include a fuel cell system, the electrochemical cell stack 102 may include a fuel cell stack, and the electrochemical cells 104 may include fuel cells. Each electrochemical cell 104 may include a membrane electrode assembly (MEA) 106 or a unitized electrode assembly (UEA) sandwiched between a pair of bipolar plates (BPPs) 200. For example, the MEA 106 may include a membrane 108 accommodating a catalyst 110 (e.g., including an anode layer and a cathode layer on opposite sides of the membrane 108). The BPPs 200 provide structural support to the electrochemical cell stack 102 and electrically connect the electrochemical cells 104 in series so that electricity generated at the MEAs 106 of the electrochemical cell stack 102 produces a usable output voltage.

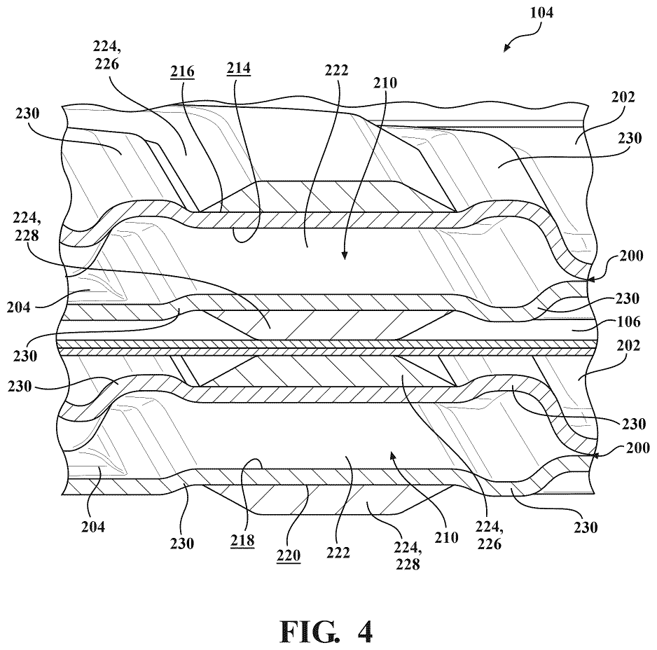

Each BPP 200 includes an anode plate or panel 202 and a cathode plate or panel 204 (FIG. 4). The anode plate 202 and the cathode plate 204 may comprise a metallic material. For example, the anode plate 202 and the cathode plate 204 may be formed from plates of steel, stainless steel (e.g., 304 stainless steel, 316 stainless steel, or ferritic stainless steel), plated steel, aluminum, titanium, or surface-treated metal that may have a thickness of about 300 microns or less. The anode plate 202 and the cathode plate 204 are stamped to form and joined together, such as by welding (e.g., laser welding), brazing, bonding with adhesive, or crimping at the outer peripheries of the plates. When disposed within the electrochemical cell stack 102, the anode plates 202 and cathode plates 204 may be arranged in an alternating pattern so that an anode plate 202 engages one side of an MEA 106 and a cathode plate 204 engages the opposite side of the MEA 106 to channel electricity in a given direction through the electrochemical cell stack 102.

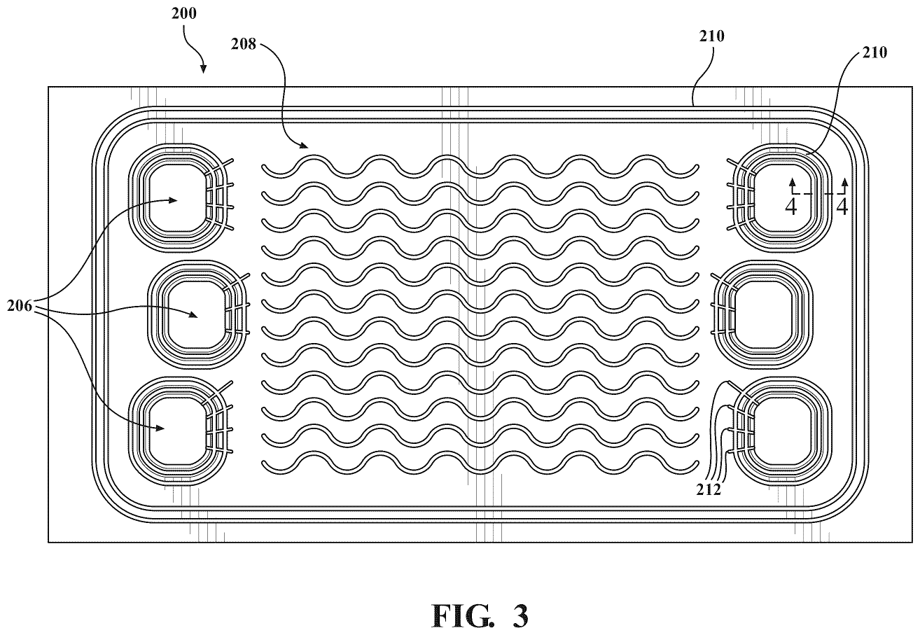

As shown in FIGS. 2 and 3, respective openings 206 are formed through the BPPs 200 and align with respective openings 112 formed through the MEAs 106 to define passageways or headers along the electrochemical cell stack 102 that allow fluid communication between electrochemical cells 104. For example, respective passageways extending between the BPPs 200 and MEAs 106 of the electrochemical cell stack 102 may carry oxygen containing gas, hydrogen fuel gas, and coolant to flow between the electrochemical cells 104 of the electrochemical cell stack 102. Each BPP 200 defines a flow field 208 across an outer face of the BPP 200 to allow for flow of fluid between the BPP 200 and the MEA 106, where the flow field 208 may include a series of channels or valleys and protrusions or lands that guide flow across the BPP 200 and between two or more openings 206 (i.e., an inlet opening and an outlet opening).

As described further below, the BPP 200 includes one or more beads or bead regions 210, raised relative to the flow field 208 and that engage respective structures within the electrochemical cell stack 102 to separate a portion of the BPP 200 from the MEA 106 to allow for fluid communication therebetween and to seal portions of the flow field 208 and contain fluid flow along desired paths. For example, the bead 210 may be formed about an outer peripheral region of the BPP 200 and configured to engage a side of the MEA 106 and/or another BPP 200 to seal the outer edge of the flow field 208. Further, the bead 210 may be at least partially formed about an opening 206 and configured to engage a side of the MEA 106 to fluidly isolate or allow fluid communication between the opening 206 and the flow field 208. That is, the bead 210 may circumscribe the opening 206 to fluidly isolate the opening 206 and the flow field 208 or the bead 210 may partially circumscribe the opening 206 to allow fluid flow between the opening 206 and the flow field 208, such that the fluid flowing through the opening 206 may only be delivered to designated portions of the electrochemical cell stack 102. For example, one or more channels or tunnels 212 may extend between an opening 206 and the flow field 208 through the bead region 210 to fluidly couple that opening 206 and the flow field 208. Thus, the beads 210 space the BPP 200 from the MEA 106 to allow at least one of the oxygen gas, hydrogen gas, water, and coolant to flow across the flow field surface 208 of the BPP 200 between inlet and outlet openings 206. Compression forces at the bead regions 210 may maintain the seals between adjacent electrochemical cells 104. Thus, structural integrity of the beads 210 is critical to prevent leakage across the electrochemical cell stack 102.

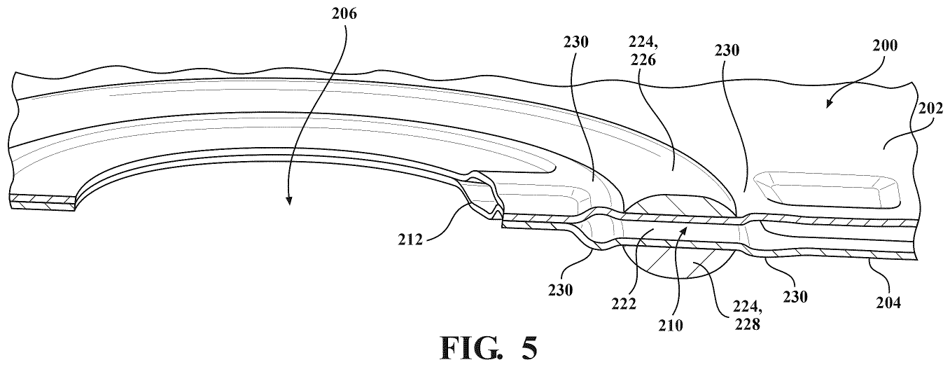

As shown in FIGS. 4-6F, the anode plate 202 has an interior side 214 and an exterior side 216 opposite the interior side 214. Likewise, the cathode plate 204 has an interior side 218 and an exterior side 220 opposite the interior side 218. The interior side 214 of the anode plate 202 faces the interior side 218 of the cathode plate 204, with the interior side 214 of the anode plate 202 spaced from the interior side 218 of the cathode plate 204 at the bead region 210 of the BPP 200 to define a chamber or cavity 222 and raise the bead 210 relative to the flow field 208. The chamber 222 may facilitate fluid flow between the opening 206 and the flow field 208. Portions of the anode plate 202 may be coupled or engaged to portions of the cathode plate 204 adjacent to the bead region 210, such as via welding, to join the anode plate 202 and the cathode plate 204 and fluidly seal the chamber 222.

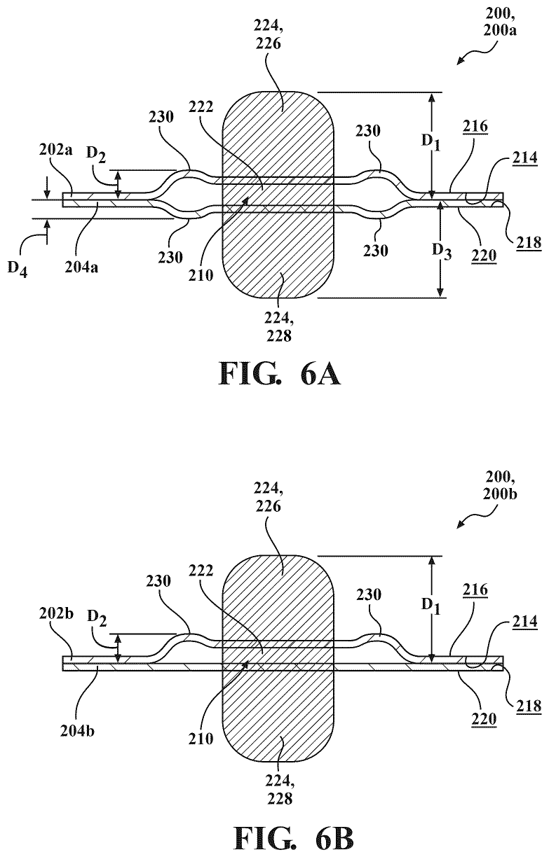

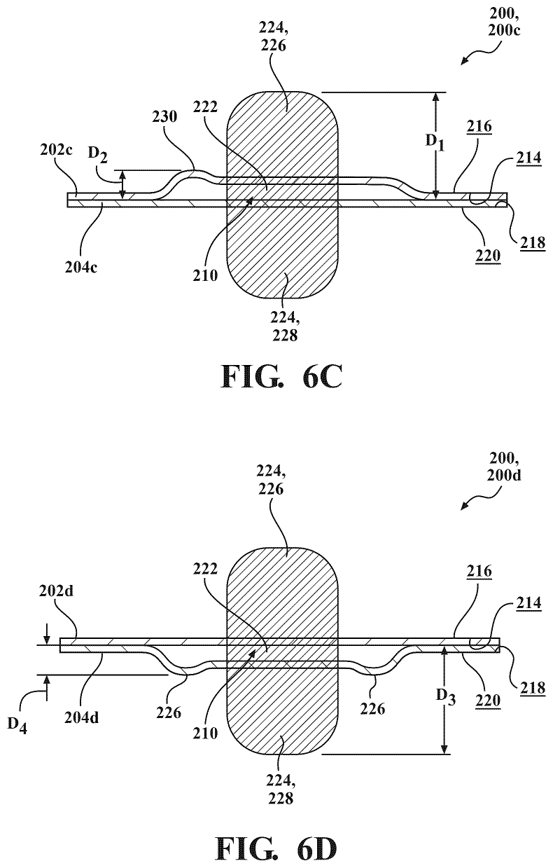

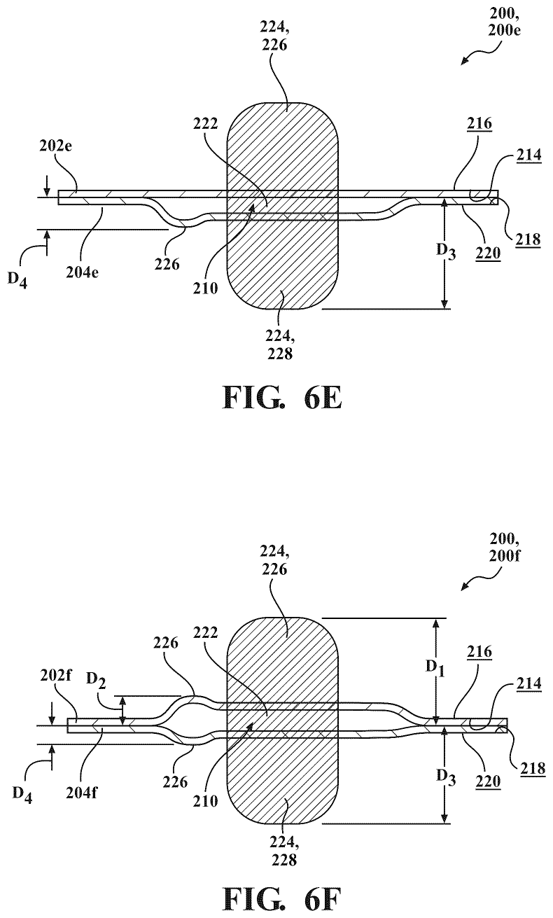

Each bead 210 is partially formed from spacing between the anode plate 202 and the cathode plate 204. Because the anode plate 202 and the cathode plate 204 are formed from metallic plates having a substantially uniform thickness, part of the bead 210 is formed as the result of stamping into the anode plate 202, the cathode plate 204, or both the anode plate 202 and the cathode plate 204, thus resulting in the chamber 222 being formed between the anode plate 202 and the cathode plate 204. For example, and with specific reference to FIG. 6A, both the anode plate 202 and the cathode plate 204 are stamped at the bead region 210 during manufacturing of the BPP 200. In this configuration, both the anode plate 202 and the cathode plate 204 include a contoured surface at the bead region 210 to space the portion of the interior side 214 of the anode plate 202 at the bead region from the portion of the interior side 218 of the cathode plate 204 at the bead region 210. In another example, and with specific reference to FIGS. 6B and 6C, only the anode plate 202 is stamped at the bead region 210 during manufacturing of the BPP 200 and the cathode plate 204 is substantially planar or flat. In this configuration, only the anode plate 202 includes a contoured surface at the bead region 210 to space the portion of the interior side 214 of the anode plate 202 at the bead region 210 from the portion of the interior side 218 of the cathode plate 204 at the bead region 210. In another example, and with specific reference to FIGS. 6D and 6E, only the cathode plate 204 is stamped at the bead region 210 during manufacturing of the BPP 200 and the anode plate 202 is substantially planar or flat. In this configuration, only the cathode plate 204 includes a contoured surface at the bead region 210 to space the portion of the interior side 218 of the cathode plate 204 at the bead region 210 from the portion of the interior side 214 of the anode plate 202 at the bead region 210.

The BPP 200 also includes an elastomeric bead 224 disposed at the bead region 210. The elastomeric bead 224 is formed from at least one of a polymer or polymer-like material or any suitable material configured to compress and/or flex to seal between adjacent surfaces, such as a silicone-based polymer, an acrylic-based polymer, and a urethane-based polymer. In further configurations, the elastomeric bead 224 may be made from ethylene propylene diene terpolymer (EPDM) or fluorocarbon-based fluoroelastomer (FKM) such as those defined by ASTM International standard D1418 and ISO standard 1629. The elastomeric bead 224 may have a cured hardness between about 40 and 70 Shore A. The elastomeric bead 224 includes a first portion 226 and a second portion 228, where the first portion 226 is disposed at the exterior side 216 of the anode plate 202 at the bead region 210 and the second portion 228 is disposed at the exterior side 220 of the cathode plate 204 at the bead region 210. As assembled within the electrochemical cell stack 102, the elastomeric bead 224 is configured to engage with the MEA 106. Specifically, the first portion 226 of the elastomeric bead 224 may engage with one of the MEA 106 included at the electrochemical cell stack 102, and the second portion 228 of the elastomeric bead 224 may engage with another of the MEA 106 included at the electrochemical cell stack 102. Both the elastomeric bead 224 and the metallic bead region 210 are configured to cooperatively resist compression forces experienced at the BPP 200. Furthermore, the elastomeric bead 224 and the bead region 210 separate a portion of the BPP 200 from the MEA 106 to allow for fluid communication therebetween and to seal portions of the flow field 208, contain fluid flow along desired paths, sustain in-plane lateral gas pressures, and reduce the potential for leaks from gas permeation.

The bead region 210 of the BPP 200 may also include at least one protrusion or stopper 230. One or more of the protrusions 230 may be included at the anode plate 202, the cathode plate 204, or both the anode plate 202 and the cathode plate 204. As discussed further below, the one or more protrusions 230 are configured to enhance the ability of the elastomeric bead 224 to resist and seal lateral gas pressures and may also provide elasticity to the bead region 210. In other words, the protrusion 230 allows the bead region 210 to elastically deform and flex, thus enhancing sealing capabilities of the bead region 210 and elastomeric bead 224 between structures within the electrochemical cell stack 102.

FIG. 6A shows a first example BPP 200a where an anode plate 202a includes the pair of protrusions 230 at respective side or outboard portions of the bead region 210 and a cathode plate 204a also includes the pair of protrusions 230 at respective side or outboard portions of the bead region 210. The first portion 226 of the elastomeric bead 224 is disposed at a planar or flat, central portion of the anode plate 202a at the bead region 210 between the respective protrusions 230. Similarly, the second portion 228 of the elastomeric bead 224 is disposed at a planar or flat, central portion of the cathode plate 204a at the bead region 210 between the respective protrusions 230.

In this configuration, the pair of protrusions 230 at the anode plate 202a extend further from the cathode plate 204a than the planar portion of the contoured surface of the anode plate 202a at the bead region 210. In a similar manner, the pair of protrusions 230 at the cathode plate 204a extend further from the anode plate 202a than the planar portion of the contoured surface of the cathode plate 204a at the bead region 210. The first portion 226 of the elastomeric bead 224 at the anode plate 202a extends a distance DI away from the cathode plate 204a that is greater than a distance D2 that the pair of protrusions 230 at the anode plate 202a extend away from the cathode plate 204a. The second portion 228 of the elastomeric bead 224 at the cathode plate 204a extends a distance D3 away from the anode plate 202a that is greater than a distance D4 the pair of protrusions 230 at the cathode plate 204a extend away from the anode plate 202a.

In this way, the protrusions 230 at the anode plate 202a and the cathode plate 204a are disposed adjacent the elastomeric bead 224 and laterally support the elastomeric bead 224 against lateral forces from both sides of the elastomeric bead 224. Optionally, a gap or clearance may be disposed between the protrusions 230 and the elastomeric bead 224 to accommodate compression of the elastomeric bead 224 into space between the protrusions 230. The contoured surfaces of the anode plate 202a and the cathode plate 204a, and thus the protrusions 230 and substantially planar portions, as well as the first portion 226 and the second portion 228 of the elastomeric bead 224 may be substantially aligned with one another at the bead region 210.

With reference to FIG. 6B, a second example BPP 200b has an anode plate 202b that includes the pair of protrusions 230 and a cathode plate 204b that is free of protrusions 230. Further, the cathode plate 204b is free of contouring at the bead region 210 such that the cathode plate 204b is substantially planar or flat at the bead region 210 and the anode plate 202b extends away from the cathode plate 204b to define the chamber 222 therebetween. In this configuration, the pair of protrusions 230 at the anode plate 202b are disposed at respective side or outboard portions of the bead region 210 and extend further from the cathode plate 204b than the planar portion of the contoured surface of the anode plate 202b at the bead region 210 between the protrusions 230. Furthermore, the first portion 226 of the elastomeric bead 224 is disposed at the bead region 210 between the pair of protrusions 230 at the exterior side 216 of the anode plate 202b. The first portion 226 of the elastomeric bead 224 at the anode plate 202b extends the distance D1 away from the cathode plate 204b that is greater than the distance D2 the pair of protrusions 230 at the anode plate 202b extend away from the cathode plate 204b.

Thus, the protrusions 230 at the anode plate 202b are disposed adjacent the first portion 226 of the elastomeric bead 224 and laterally support the first portion 226 of the elastomeric bead 224 against lateral forces from both sides. Optionally, a gap or clearance may be disposed between the protrusions 230 and the first portion 226 of the elastomeric bead 224 to accommodate compression of the elastomeric bead 224 into space between the protrusions 230. The second portion 228 of the elastomeric bead 224 is disposed at the exterior side 220 of the cathode plate 204b and is substantially aligned with the first portion 226 of the elastomeric bead 224 at the anode plate 202b.

Referring to FIG. 6C, a third example BPP 200c has an anode plate 202c that includes one protrusion 230 at one side or outboard portion of the bead region 210 and a cathode plate 204c is free of protrusions 230. Further, the cathode plate 204c is free of contouring at the bead region 210 such that the cathode plate 204c is substantially planar or flat at the bead region 210 and the anode plate 202c extends away from the cathode plate 204c to define the chamber 222 therebetween. In this configuration, the protrusion 230 at the anode plate 202c extends further from the cathode plate 204c than the planar portion of the contoured surface of the anode plate 202c at the bead region 210. Furthermore, the first portion 226 of the elastomeric bead 224 is disposed at the bead region 210 and adjacent to the protrusion 230 at the exterior side 216 of the anode plate 202c. The first portion 226 of the elastomeric bead 224 at the anode plate 202c extends the distance D1 away from the cathode plate 204c that is greater than the distance D2 the protrusion 230 at the anode plate 202c extends away from the cathode plate 204c.

Accordingly, the protrusion 230 at the anode plate 202c is disposed adjacent the first portion 226 of the elastomeric bead 224 and laterally supports the first portion 226 of the elastomeric bead 224 against lateral forces from one side. Optionally, a gap or clearance may be disposed between the protrusion 230 and the first portion 226 of the elastomeric bead 224 to accommodate compression of the elastomeric bead 224. The second portion 228 of the elastomeric bead 224 is disposed at the exterior side 220 of the cathode plate 204c and is substantially aligned with the first portion 226 of the elastomeric bead 224 at the anode plate 202c.

As shown in FIG. 6D, a fourth example BPP 200d has a cathode plate 204d that includes the pair of protrusions 230 and an anode plate 202d that is free of protrusions 230. Further, the anode plate 202d is free of contouring at the bead region 210 such that the anode plate 202d is substantially planar or flat at the bead region 210 and the cathode plate 204d extends away from the anode plate 202d to define the chamber 222 therebetween. In this configuration, the pair of protrusions 230 at the cathode plate 204d are disposed at respective side or outboard portions of the bead region 210 and extend further from the anode plate 202d than the planar portion of the contoured surface of the cathode plate 204d at the bead region 210 between the protrusions 230. Furthermore, the second portion 228 of the elastomeric bead 224 is disposed at the bead region 210 between the pair of protrusions 230 at the exterior side 220 of the cathode plate 204d. The second portion 228 of the elastomeric bead 224 at the cathode plate 204d extends the distance D3 away from the anode plate 202d that is greater than the distance D4 the pair of protrusions 230 at the cathode plate 204d extend away from the anode plate 202d.

Thus, the protrusions 230 at the cathode plate 204d are disposed adjacent the second portion 228 of the elastomeric bead 224 and laterally support the second portion 228 of the elastomeric bead 224 against lateral forces from both sides. Optionally, a gap or clearance may be disposed between the protrusions 230 and the second portion 228 of the elastomeric bead 224 to accommodate compression of the elastomeric bead 224 into space between the protrusions 230. The first portion 226 of the elastomeric bead 224 is disposed at the exterior side 216 of the anode plate 202d and is substantially aligned with the second portion 228 of the elastomeric bead 224 at the cathode plate 204d.

FIG. 6E shows a fifth example BPP 200e, where a cathode plate 204e includes one protrusion 230 and an anode plate 202e is free of protrusions 230. Further, the anode plate 202e is free of contouring at the bead region 210 such that the anode plate 202e is substantially planar or flat at the bead region 210 and the cathode plate 204e extends away from the anode plate 202e to define the chamber 222 therebetween. In this configuration, the protrusion 230 at the cathode plate 204e is disposed at one side or outboard portion of the cathode plate 204e and extends further from the anode plate 202e than the planar portion of the contoured surface of the cathode plate 204e at the bead region 210. Furthermore, the second portion 228 of the elastomeric bead 224 is disposed at the bead region 210 and adjacent to the protrusion 230 at the exterior side 220 of the cathode plate 204e. The second portion 228 of the elastomeric bead 224 at the cathode plate 204e extends the distance D3 away from the anode plate 202e that is greater than the distance D4 the protrusion 230 at the cathode plate 204e extends away from the anode plate 202e.

The protrusion 230 at the cathode plate 204e is disposed adjacent the second portion 228 of the elastomeric bead 224 and laterally supports the second portion 228 of the elastomeric bead 224 against lateral forces from one side. Optionally, a gap or clearance may be disposed between the protrusion 230 and the second portion 228 of the elastomeric bead 224 to accommodate compression of the elastomeric bead 224. The first portion 226 of the elastomeric bead 224 is disposed at the exterior side 216 of the anode plate 202e and is substantially aligned with the second portion 228 of the elastomeric bead 224 at the cathode plate 204e.

In another example, and with reference to FIG. 6F, a sixth example BPP 200f has an anode plate 202f that includes one protrusion 230 and a cathode plate 204f that also includes one protrusion 230. In this configuration, the protrusion 230 at the anode plate 202f is disposed at one side or outboard portion of the anode plate 202f and extends further from the cathode plate 204f than the planar portion of the contoured surface of the anode plate 202f at the bead region 210. In a similar manner, the protrusion 230 at the cathode plate 204f is disposed at one side or outboard portion of the cathode plate 204f and extends further from the anode plate 202f than the planar portion of the contoured surface of the cathode plate 204f at the bead region 210. Although shown as aligned with one another, it should be understood that the protrusions 230 of the anode plate 202f and the cathode plate 204f may be disposed at opposing sides of the bead region 210 from one another.

Furthermore, in this configuration, the first portion 226 of the elastomeric bead 224 is disposed at the bead region 210 and adjacent to the protrusion 230 at the exterior side 216 of the anode plate 202f. The first portion 226 of the elastomeric bead 224 at the anode plate 202f extends the distance D1 away from the cathode plate 204f that is greater than a distance D2 the protrusion 230 at the anode plate 202f extends away from the cathode plate 204f. In a similar manner, the second portion 228 of the elastomeric bead 224 is disposed at the bead region 210 and adjacent to the protrusion 230 at the exterior side 220 of the cathode plate 204f. The second portion 228 of the elastomeric bead 224 at the cathode plate 204f extends a distance D3 away from the anode plate 202f that is greater than a distance D4 the protrusion 230 at the cathode plate 204f extends away from the anode plate 202f.

The protrusion 230 at the anode plate 202f is disposed adjacent the first portion 226 of the elastomeric bead 224 and laterally supports the first portion 226 of the elastomeric bead 224 against lateral forces from one side. Similarly, the protrusion 230 at the cathode plate 204f is disposed adjacent the second portion 228 of the elastomeric bead 224 and laterally supports the second portion 228 of the elastomeric bead 224 against lateral forces from one side. Optionally, gaps or clearances may be disposed between the respective protrusions 230 and the first and second portions 226, 228 of the elastomeric bead 224 to accommodate compression of the elastomeric bead 224. The first portion 226 of the elastomeric bead 224 at the anode plate 202f is substantially aligned with the second portion 228 of the elastomeric bead 224 at the cathode plate 204f.

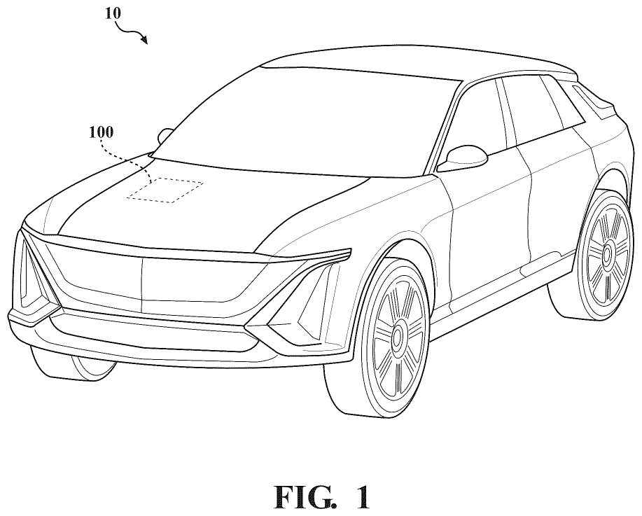

With reference to FIGS. 1-6F, although the BPP 200 is shown as having equal sized and shaped portions 226, 228 of the elastomeric bead 224 at the anode plate 202 and the cathode plate 204, it should be understood that the portions 226, 228 of the elastomeric bead 224 may be differently configured from one another. For example, one portion of the elastomeric bead 224 may extend a further distance from the respective anode plate 202 or cathode plate 204 as compared to the other portion of the elastomeric bead 224. Optionally, the first portion 226 and the second portion 228 of the elastomeric bead 224 may have different widths from one another.

Thus, the BPP 200 described herein having a hybrid seal including the metallic bead region 210 of the anode plate 202 and the cathode plate 204 and the elastomeric bead 224 disposed at the bead region 210 provides improved sealing between electrochemical cells 104 of the electrochemical cell stack 102 and improved response to compression forces at the electrochemical cell stack 102. For example, the elastomeric bead 224 may have a thickness of between 250 microns and 500 microns or greater such that the bead region 210 and the elastomeric bead 224 cooperatively resist compression forces experienced at the BPP 200. In other words, the metallic bead region 210 may partially flex and the elastomeric bead 224 may partially compress responsive to compression forces. Further, the metallic bead region 210 may include one or more protrusions 230, such as for positioning the elastomeric bead 224 and supporting the elastomeric bead 224 against lateral forces, thereby improving sealing.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A bipolar plate comprising:
a metallic anode plate having an interior side and an exterior side opposite the interior side;
a metallic cathode plate having an interior side and an exterior side opposite the interior side, the interior side of the cathode plate facing the interior side of the anode plate;
a bead region, wherein a portion of the interior side of the anode plate at the bead region is spaced from a portion of the interior side of the cathode plate at the bead region; and
an elastomeric bead including a first portion and a second portion, the first portion disposed at the exterior side of the anode plate at the bead region, and the second portion disposed at the exterior side of the cathode plate at the bead region, the elastomeric bead and the bead region configured to cooperatively resist compression forces experienced at the bipolar plate.

2. The bipolar plate of claim 1, wherein the portion of the anode plate at the bead region includes a protrusion extending away from the cathode plate, the first portion of the elastomeric bead disposed at the portion of the anode plate at the bead region and adjacent to the protrusion.

3. The bipolar plate of claim 2, wherein the first portion of the elastomeric bead extends a distance away from the cathode plate that is greater than a distance the protrusion extends away from the cathode plate.

4. The bipolar plate of claim 1, wherein the portion of the anode plate at the bead region includes a pair of protrusions extending away from the cathode plate, the first portion of the elastomeric bead disposed at the portion of the anode plate at the bead region and between the pair of protrusions.

5. The bipolar plate of claim 1, wherein the portion of the cathode plate at the bead region includes a protrusion extending away from the anode plate, the second portion of the elastomeric bead disposed at the portion of the cathode plate at the bead region and adjacent to the protrusion.

6. The bipolar plate of claim 5, wherein the second portion of the elastomeric bead extends a distance away from the anode plate that is greater than a distance the protrusion extends away from the anode plate.

7. The bipolar plate of claim 1, wherein the portion of the cathode plate at the bead region includes a pair of protrusions extending away from the anode plate, the second portion of the elastomeric bead disposed at the portion of the cathode plate at the bead region and between the pair of protrusions.

8. The bipolar plate of claim 1, wherein portions of the interior side of the anode plate adjacent to the bead region and portions of the interior side of the cathode plate adjacent to the bead region engage one another.

9. The bipolar plate of claim 1, wherein at least one selected from the group consisting of (i) the anode plate includes a contoured surface at the bead region to space the portion of the interior side of the anode plate at the bead region from the portion of the interior side of the cathode plate at the bead region and (ii) the cathode plate includes a contoured surface at the bead region to space the portion of the interior side of the cathode plate at the bead region from the portion of the interior side of the anode plate at the bead region.

10. The bipolar plate of claim 1, wherein the elastomeric bead includes at least one selected from the group consisting of: i) a silicone-based polymer, ii) an acrylic-based polymer, iii) a urethane-based polymer, iv) an ethylene propylene diene terpolymer, and v) a fluorocarbon-based fluoroelastomer.

11. An electrochemical cell system comprising:
an electrochemical cell stack including a plurality of electrochemical cells, wherein at least one electrochemical cell of the plurality of electrochemical cells includes a membrane electrode assembly sandwiched between a pair of bipolar plates, each bipolar plate of the pair of bipolar plates including:
a metallic anode plate having an interior side and an exterior side opposite the interior side;
a metallic cathode plate having an interior side and an exterior side opposite the interior side, the interior side of the cathode plate facing the interior side of the anode plate;
a bead region, wherein a portion of the interior side of the anode plate at the bead region is spaced from a portion of the interior side of the cathode plate at the bead region; and
an elastomeric bead including a first portion and a second portion, the first portion disposed at the exterior side of the anode plate at the bead region, and the second portion disposed at the exterior side of the cathode plate at the bead region, the elastomeric bead and the bead region configured to cooperatively resist compression forces experienced at the bipolar plate.

12. The electrochemical cell system of claim 11, wherein the portion of the anode plate at the bead region includes a protrusion extending away from the cathode plate, the first portion of the elastomeric bead disposed at the portion of the anode plate at the bead region and adjacent to the protrusion.

13. The electrochemical cell system of claim 11, wherein the portion of the anode plate at the bead region includes a pair of protrusions extending away from the cathode plate, the first portion of the elastomeric bead disposed at the portion of the anode plate at the bead region and between the pair of protrusions.

14. The electrochemical cell system of claim 11, wherein the portion of the cathode plate at the bead region includes a protrusion extending away from the anode plate, the second portion of the elastomeric bead disposed at the portion of the cathode plate at the bead region and adjacent to the protrusion.

15. The electrochemical cell system of claim 11, wherein the portion of the cathode plate at the bead region includes a pair of protrusions extending away from the anode plate, the second portion of the elastomeric bead disposed at the portion of the cathode plate at the bead region and between the pair of protrusions.

16. A system operable with a vehicle, the system comprising:
an electrochemical cell stack including a plurality of electrochemical cells, wherein at least one electrochemical cell of the plurality of electrochemical cells includes a membrane electrode assembly sandwiched between a pair of bipolar plates, each bipolar plate of the pair of bipolar plates including:
a metallic anode plate having an interior side and an exterior side opposite the interior side;
a metallic cathode plate having an interior side and an exterior side opposite the interior side, the interior side of the cathode plate facing the interior side of the anode plate;
a bead region, wherein a portion of the interior side of the anode plate at the bead region is spaced from a portion of the interior side of the cathode plate at the bead region; and
an elastomeric bead including a first portion and a second portion, the first portion disposed at the exterior side of the anode plate at the bead region, and the second portion disposed at the exterior side of the cathode plate at the bead region, the elastomeric bead and the bead region configured to cooperatively resist compression forces experienced at the bipolar plate.

17. The system of claim 16, wherein the portion of the anode plate at the bead region includes a protrusion extending away from the cathode plate, the first portion of the elastomeric bead disposed at the portion of the anode plate at the bead region and adjacent to the protrusion.

18. The system of claim 16, wherein the portion of the anode plate at the bead region includes a pair of protrusions extending away from the cathode plate, the first portion of the elastomeric bead disposed at the portion of the anode plate at the bead region and between the pair of protrusions.

19. The system of claim 16, wherein the portion of the cathode plate at the bead region includes a protrusion extending away from the anode plate, the second portion of the elastomeric bead disposed at the portion of the cathode plate at the bead region and adjacent to the protrusion.

20. The system of claim 16, wherein the portion of the cathode plate at the bead region includes a pair of protrusions extending away from the anode plate, the second portion of the elastomeric bead disposed at the portion of the cathode plate at the bead region and between the pair of protrusions.
